(19) United States
(12) Patent Application Publication
(10) Pub. No.: US 2013/0212284 A1
(43) Pub. Date: Aug. 15, 2013

(54) METHOD AND APPARATUS FOR MAINTAINING INFORMATION ABOUT SUBSCRIPTION SERVERS

(71) Applicants: Alexander Milinski, Munchen (DE); Jiadong Shen, Munchen (DE)

(72) Inventors: Alexander Milinski, Munchen (DE); Jiadong Shen, Munchen (DE)

(73) Assignee: NOKIA SIEMENS NETWORKS OY, Espoo (FI)

(21) Appl. No.: 13/877,501

(22) PCT Filed: Oct. 6, 2010
(86) PCT No.: PCT/EP2010/064932

§ 371 Date: Apr. 3, 2013

(51) Int. Cl. G06F 15/173

(52) U.S. Cl. CPC H04L 47/70
USPC 709/226

(57) ABSTRACT

The invention relates to transferring subscription data of a user from a first subscription server to a second subscription server, and involving the first subscription server in handling of terminating requests to the user, until the user performs registration procedure, and involving the second subscription server in handling of terminating requests to the user, after the user has performed the registration procedure.

### TECHNICAL FIELD OF THE INVENTION

The present invention relates to a mechanism for subscription server allocation. In particular, the present invention is related to a method and apparatus for maintaining information relating to a first subscription server allocated to a user and information relating to a second subscription server previously allocated to the user.

### BACKGROUND OF THE INVENTION

Within the IP (Internet Protocol) Multimedia Subsystem (IMS) as defined by 3^{rd} Generation Partnership Project (3GPP) Session Initiation Protocol (SIP) defined by Internet Engineering Task Force (IETF) is used for controlling communication. SIP is an application-layer control protocol for creating, modifying, and terminating sessions with one or more participants. These sessions may include Internet multimedia conferences, Internet telephone calls, and multimedia distribution. Members in a session can communicate via multicast or via a mesh of unicast relations, or a combination of these. Session Description Protocol (SDP) is a protocol which conveys information about media streams in multimedia sessions to allow the recipients of a session description to participate in the session. The SDP offers and answers can be carried in SIP messages. Diameter protocol has been defined by IETF and is intended to provide an Authentication, Authorization and Accounting (AAA) framework for applications such as network access or IP mobility.

Generally, for properly establishing and handling a communication connection between network elements such as a user equipment and another communication equipment or user equipment, a database, a server, etc., one or more intermediate network elements such as control network elements, support nodes, service nodes and interworking elements are involved which may belong to different communication networks.

In the IMS context, there may be more than one (logical) home subscriber servers (HSS). In this case the IMS architecture defines a subscription locator function (SLF). The SLF is a database, which stores the mapping from user name to the HSS name for all users.

Sometimes there is a need to move a user from one HSS to another. In this case, the HSS configuration in the SLF must also be changed.

The HSS maintain both static and dynamic user data. While it is quite easy to migrate static user data from an old HSS to a new HSS, moving dynamic user data, such as registration related information, can be more complex.

Copying only the static information from the old HSS to the new HSS is less time restrictive. Thus, if only the SLF configuration is changed when a user is moved from one HSS to another, the SLF entry points to the other HSS which does not have dynamic registration information of the user. Thus an incoming terminating call can perform an interrogation at the

HSS without registration information and as a consequence the call can be routed, for example, to the mailbox of the user rather than to the user.

### SUMMARY OF THE INVENTION

The present invention can overcome above drawbacks by providing an apparatus, a method and a computer program product comprising maintaining information relating to a first subscription server allocated to a user and information relating to a second subscription server previously allocated to the user,
indicating a subscription server for the user, wherein the indicating can comprise:
to indicate the second subscription server as the subscription server for the user, as response to receiving a request associated with a session initiation for the user, and,
to indicate the first subscription server as the subscription server for the user, as response to receiving a request associated with registration procedure of the user.

The indicating can comprise indicating the first subscription server instead of the second subscription server as the subscription server for the user as response to receiving a request associated with a session initiation, after receiving a request associated with registration procedure of the user, for example, after receiving the first request associated with registration procedure after changing the information relating to the first subscription server.

The apparatus, method and computer program product can comprise removing the information relating to the second subscription server previously allocated to the user, as response to receiving a request associated with registration procedure of the user.

The apparatus, method and computer program product can comprise receiving the request associated with the session initiation for the user, wherein the request can comprise Location-Info-Request message, and/or, receiving the request associated with the registration procedure of the user, wherein the request can comprise User-Authorization-Request message.

The apparatus, method and computer program product can comprise transmitting the indicated subscription server in a User-Authorization-Answer message or in a Location-Info-Answer message to a call state control function or to an application server.

The apparatus, method and computer program product can comprise changing the information relating to the first subscription server allocated to the user, wherein the changing can comprise to change the previous information relating to the first subscription server to be the information relating to the second subscription server previously allocated to the user, when changing the information relating to the first subscription server.

The registration procedure can comprise the user refreshing its registration. The information relating to the first subscription server and the information relating to the second subscription server can comprise a name or an address of a home subscriber server.

Further, a system, a method and a computer program product are provided, comprising transferring subscription data of a user from a first subscription server to a second subscription server, involving the first subscription server in handling of terminating requests to the user, before or until the user performs registration procedure, and involving the second subscription server in handling of terminating requests to the user, after or from the moment the user has performed the registration procedure.

The involving can comprise transmitting information about the first or the second subscription server from a subscription locator entity to a session handling entity.

The registration procedure can comprise the first registration of the user after transferring the subscription data or the user refreshing its registration.

The transferring can comprises transferring only part of the subscription data of the user, and wherein the transferred data can comprise at least one of a public user identity, a private user identity, a password, filter criteria and a service profile. The not transferred data can remain at the first subscription server and can comprise at least one of registration status of the user, a name of a session control entity assigned for the user and Sh notification subscription state.

Embodiments of the present invention may have one or more of following advantages:
The SLF enhancement can ensure that de-facto migration of a subscriber from an old HSS to a new HSS happens at time of re-registration.
Users can be migrated one-by-one in an easy manner without service interruption and high signalling load.

Only static information needs to be copied from old to new HSS, which is less costly.

### DESCRIPTION OF DRAWINGS

FIGS. 1 and 2 illustrate signalling between network elements relevant for the invention.

FIG. 3 illustrates examples of internal structure and functions of an apparatus implementing aspects of the invention.

FIGS. 4-7 illustrate migration of subscriber data between two HSSs according to aspects of the invention.

### DETAILED DESCRIPTION OF THE INVENTION

A Call Session Control Function (CSCF) implements a session control function in SIP layer. The CSCF can act as Proxy CSCF (P-CSCF), Serving CSCF (S-CSCF) or Interrogating CSCF (I-CSCF). The P-CSCF is the first contact point for the User Equipment (UE) within the IMS; the S-CSCF handles the session states in the network; the I-CSCF is mainly the contact point within an operator's network for all IMS connections destined to a subscriber of that network operator, or a roaming subscriber currently located within that network operator's service area.

The functions performed by the I-CSCF are, for example, assigning an S-CSCF to a user performing a SIP registration and routing SIP requests received from another network towards the S-CSCF. The S-CSCF can perform the session control services for the UE. It maintains a session state as needed by the network operator for support of the services and may be acting as Registrar, i.e. it accepts registration requests and makes its information available through the location server (e.g. HSS). The S-CSCF is the central point to users that are hosted by this S-CSCF. The S-CSCF can provide services to registered and unregistered users when it is assigned to these users. This assignment can be stored in the Home Subscriber Server (HSS).

The HSS is the master database for a given user. It is the entity containing the subscription-related information to support the network entities actually handling calls/sessions. As an example, the HSS provides support to the call control servers (CSCFs) in order to complete the routing/roaming procedures by solving authentication, authorisation, naming/addressing resolution, location dependencies, etc.

The HSS can be responsible for holding the following user related information:
User Identification, Numbering and addressing information
User Security information: Network access control information for authentication and authorization, such as password information
User Location information at inter-system level: the HSS supports the user registration, and stores inter-system location information, etc.
User profile information.

A subscription locator function (SLF) is a function which enables I-CSCF, S-CSCF and Application Server (AS) to locate the address of the server, such as a HSS, that holds the IMS subscriber data for a given user identity. The SLF can associates private and public user identities with the HSS and service and subscription repository addresses. The SLF can interface other network elements, for example, over Dx, Yc, and Dh reference points of the IMS.

Cx reference point or Cx interface is an interface between a CSCF and a HSS, supporting the transfer of data between them. The Cx reference point is based on the diameter protocol with 3GPP standard diameter applications. Dx interface can be used in conjunction with the Cx interface. I-CSCFs and S-CSCFs can access the SLF via the Dx interface which is also based on diameter protocol. Dh interface is the standard interface between the AS and the SLF.

Diameter is an authentication, authorisation, and accounting (AAA) protocol defined by the IETF and used for network access services, such as dial-up and mobile IP. The Diameter base protocol is evolved from the remote authentication dial-in user service (RADIUS) protocol.

Diameter multimedia client and Diameter multimedia server implement the Diameter multimedia application. The client is one of the communicating Diameter peers that usually initiates transactions. Examples of communication elements that may implement the Diameter multimedia client are the I-CSCF and S-CSCF. An example of a Diameter multimedia server is the HSS and the SLF.

Location-Info-Request (LIR) message is a Diameter command message that a Diameter multimedia client sends to a Diameter multimedia server to request the name of the server that is currently serving the user. Location-Info-Answer (LIA) message is a Diameter command message that a server sends as a response to a previously received Location-Info-Request message.

A User-Authorization-Request (UAR) message is a Diameter command message that a Diameter multimedia client sends to a

Diameter multimedia server to request the authorisation of the registration of a multimedia user. A User-Authorization-Answer (UAA) message is a Diameter command message that a server sends as a response to a previously received User-Authorization-Request message.

Attribute-value pair (AVP) is a generic pair of values that consists of an attribute header and the corresponding value. The AVP can be used, for example, to encapsulate protocol-specific data such as routing information, as well as authentication, authorisation, or accounting information. Diameter messages can contain AVPs to transmit information between an CSCFs and the HSS/SLF.

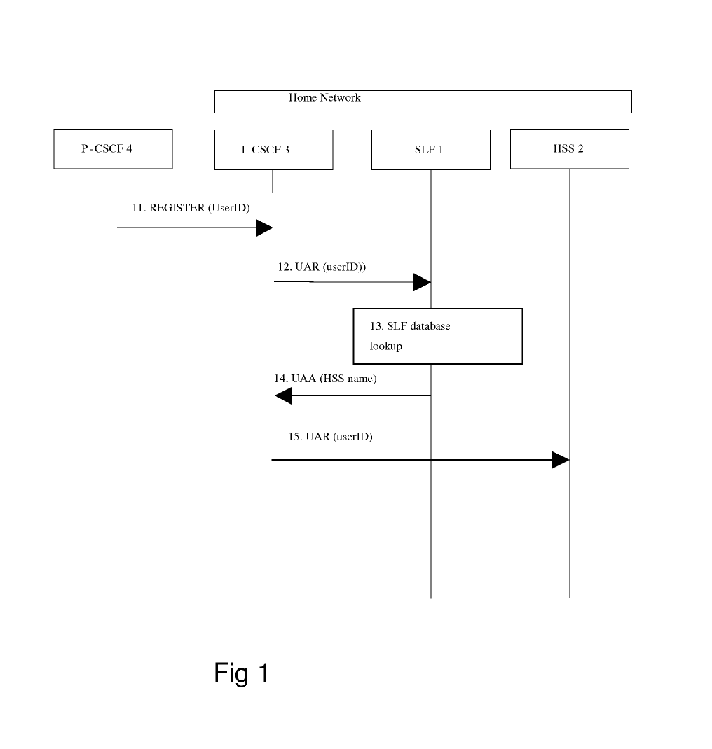

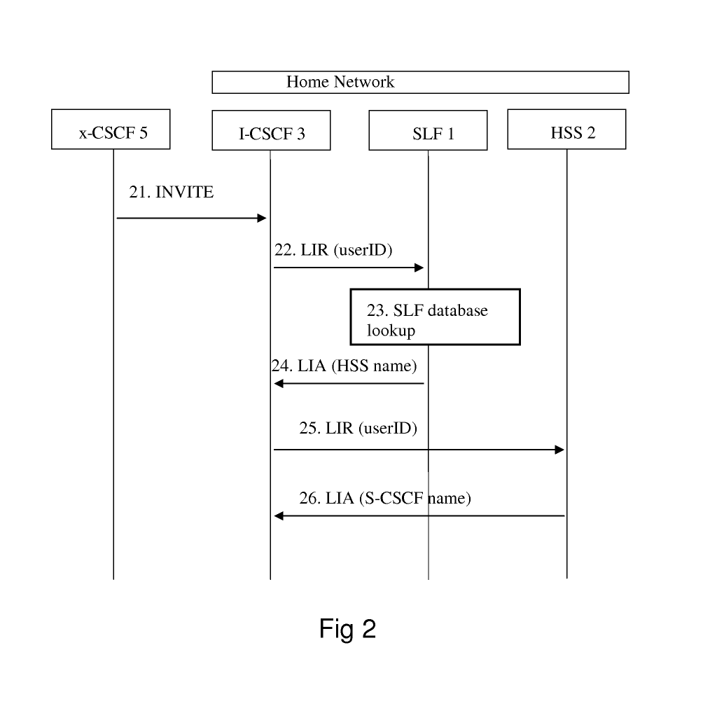

FIGS. 1 and 2 show resolution mechanism, which can enable network elements (I-CSCF, S-CSCF, AS) to find the address of the HSS, that holds subscriber data for a given user identity when multiple and separately addressable HSSs have been deployed in the network.

Generally, on SIP REGISTER and on mobile terminating SIP INVITE requests, the I-CSCF queries the HSS for subscription specific data of the user, for example, authentication parameters. If the network has more than one independently addressable HSS, the HSS where user information for a given subscriber is available has to be found. To obtain the HSS name, the CSCF query the SLF entity or the CSCF can send the query to the HSS via a Diameter Proxy Agent.

The synchronisation and configuration of the data in consistent way in the SLF and the different HSSs can be taken care by the operation and maintenance (O&M).

The CSCF can send a Dx-operation DX_SLF_QUERY and indicate a user identity of which it is looking for an HSS. The Dx-operation DX_SLF_RESP response sent by the SLF can include the HSS name. The CSCF can then continue by querying the selected HSS. An I-CSCF can forward the HSS name towards the S-CSCF. The S-CSCF can use the name to find the subscriber's HSS.

Similarly, the Dh interface can provide an operation to query the SLF from the AS (DH_SLF_QUERY) and a response to provide the HSS name towards the AS (DH_SLF_RESP). The AS can store the HSS name for the subsequent Sh-operations. SLF_QUERY and SLF_RESP over Dx and Dh interfaces can be Diameter based messages.

In FIG. 1, in signal 11 an I-CSCF 3 receives a REGISTER request from UE (not shown) via a P-CSCF 4. Next, the I-CSCF 3 can query for the location of the user's subscription data. In 12, the I-CSCF 3 can transmit a DX_SLF_QUERY (Diameter UAR) to an SLF 1. The DX_SLF_QUERY 12 can include as a parameter the user identity which is stated in the REGISTER request 11.

In 13, the SLF 1 can look up its database for the queried user identity and for corresponding HSS 2 name in which the user's subscription data can be found and can include the HSS 2 name in a DX SLF RESP 14 (Diameter UAA) which can be transmitted to the I-CSCF 3. Finally, the I-CSCF 3 can proceed in 15 by querying the appropriate HSS 2 with another Diameter UAR command.

UE can initiate periodic application level re-registration either to refresh an existing registration or in response to a change in the registration status of the UE. For periodic registration, the UE can initiate a re-registration prior to expiry of the agreed registration timer by transmitting a new REGISTER request.

In FIG. 2 similar processes as in FIG. 1 is shown, when a terminating INVITE request is received. An I-CSCF 3 at the border of the terminating user's network can receive an INVITE request 21 via another CSCF 5. The I-CSCF 3 can query for the location of the subscription data of the invited (called) user.

In 22, the I-CSCF 3 can transmit a DX_SLF_QUERY (Diameter LIR) to a SLF 1 and can include as parameter the user identity which is included in the INVITE request 21. The I-CSCF 3 can first translate the user identity into another format prior to sending it to the SLF, for example, into the Tel: URI format, if the user identity is an E.164 number in the SIP URI with user=phone parameter format

In 23, the SLF 1 can look up its database for the queried user identity and corresponding HSS 2 name in which the user's subscription data can be found and in 24 the SLF 1 can answer with a DX SLF RESP (Diameter LIA) including the HSS 2 name. In 25, the I-CSCF 3 can query the HSS 2 for current location information over Cx reference point with another Diameter LIR command. In 26, the HSS 2 can respond with a Diameter LIA response including the address of the currently assigned S-CSCF for the terminating user.

According to aspects of the invention, SLF database can be enhanced by the option to store two HSS names per user entry. In addition to the name of the newly selected HSS, the name of the previously selected HSS can be stored.

According to aspects of the invention, during normal operation, only the name of the newly selected (current) HSS can be stored. However, during migration of subscription data of a user from a first HSS to a second HSS, the name of the first HSS can be stored as previous HSS and the name of the second HSS can be stored as a new HSS.

According to aspects of the invention, relating to an SLF query (for example, Diameter LIR message), for a terminating call to the user, the SLF can return the name of the first HSS stored as the previous HSS name, if the user has not yet performed a new (re-)registration operation. Because the user has not yet performed a new (re-)registration operation, the first HSS can hold some dynamic subscription information of the user, such as registration status and S-CSCF name, so that the terminating call can be completed successfully to the user.

According to aspects of the invention, when there is the first SLF query for a (re-)registration of the user (for example, Diameter UAR message), the SLF can return the name of the second HSS stored as the new HSS. As a consequence, the user can be registered to the second HSS. The second HSS can then begin the handling of terminating calls to the user. The previous HSS name stored in the SLF can be deleted after the first SLF query for the (re-)registration of the user.

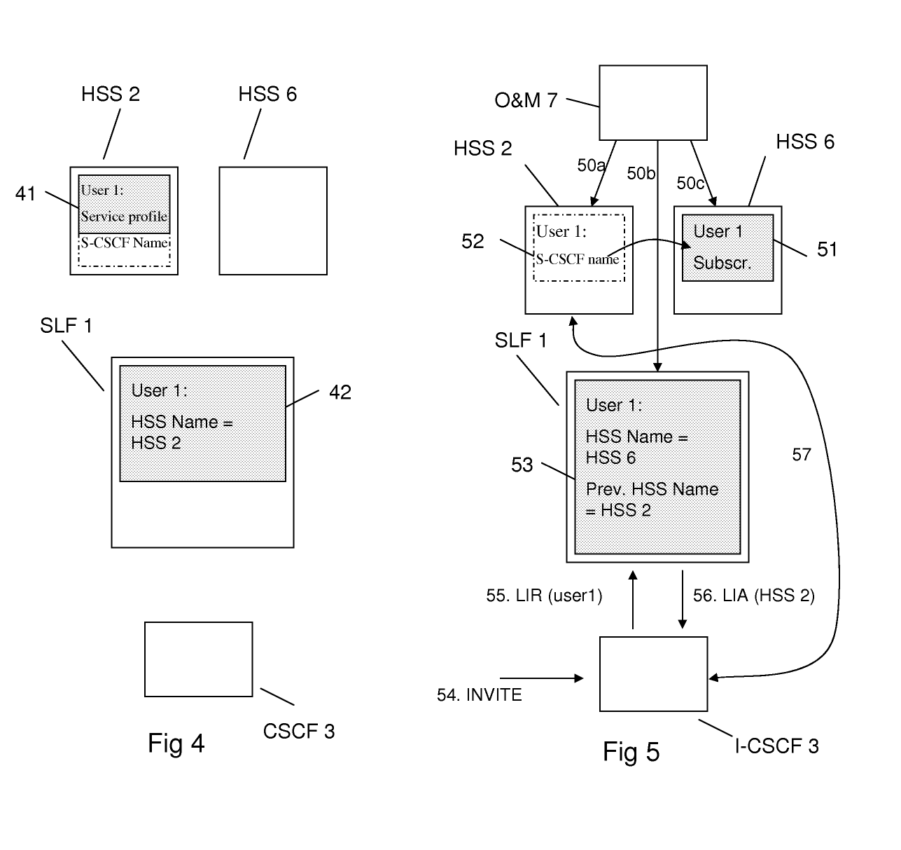

FIGS. 4-7 show aspects of the invention during different phases of migration of subscription data of a user from a first HSS 2 to a second HSS 6. Figures show which information can be stored in different network elements and relevant signaling messages.

In FIG. 4, subscription related data of multiple IMS users can be first stored in a HSS 2. The data includes also subscription data of user1 as shown with reference number 41. The subscription data can contain both dynamic and static elements. The static data can be configured by a network operator and is typically not often changed. For example, following information stored in the user profile of the user can belong to static data:
Public user identity,
Private user identity,
Password,
Filter criteria,
Service profile

Dynamic data, on the other hand, is changing more often and contain information maintained by the network elements without requiring separate configuration by the network operator every time. For example, a current registration status of the user, an assigned S-CSCF name and/or Sh notification subscription state can belong to dynamic data

In FIGS. 4-7, static data in HSSs has been illustrated with grey background color (for example, a service profile) and dynamic data with white background (for example, name of assigned S-CSCF).

An SLF 1 can maintain information on location of subscription data of the users in case the network has more than one HSS deployed. The SLF 1 can also contain a data element indication a correct HSS for the user1, as shown with reference number 42. According to the data element, the HSS 2 is currently responsible for maintaining the subscription data for the user1.

Next, as shown in FIG. 5, the network operator can move the static part of the subscription data 41, for example, a service profile 51, to another HSS 6. Reference number 52 illustrates that at least some dynamic subscription data can still remain stored in the HSS 2 and is not transferred to the HSS 6, for example, the name of an assigned S-CSCF which can be responsible for handling terminating requests to the user. The static part of the subscription data 51 can be provisioned from the O&M 7 to the HSS 6 over operation and maintenance (O&M) interface 50c. The data provisioned to the HSS 6 can be removed from the HSS 2 by the O&M 7 over O&M interface 50a.

When changing the subscription data 51 of the user1 to the HSS 6, also the configuration in the SLF 1 can be changed. According to an aspect of the invention, the name of the HSS which has previously stored the subscription data 41 of the user 1 (HSS 2) can be stored in the SLF 1 in the data element 53 of the user1, in addition to the name of the HSS in which the moved subscription data 51 is stored (HSS 6) after the HSS reconfiguration. The SLF 1 configuration can be changed, for example, by the network operator (O&M 7) over O&M interface 50b.

At some point of time, the user1 can renew its IMS registration, for example with SIP re-registration procedure.

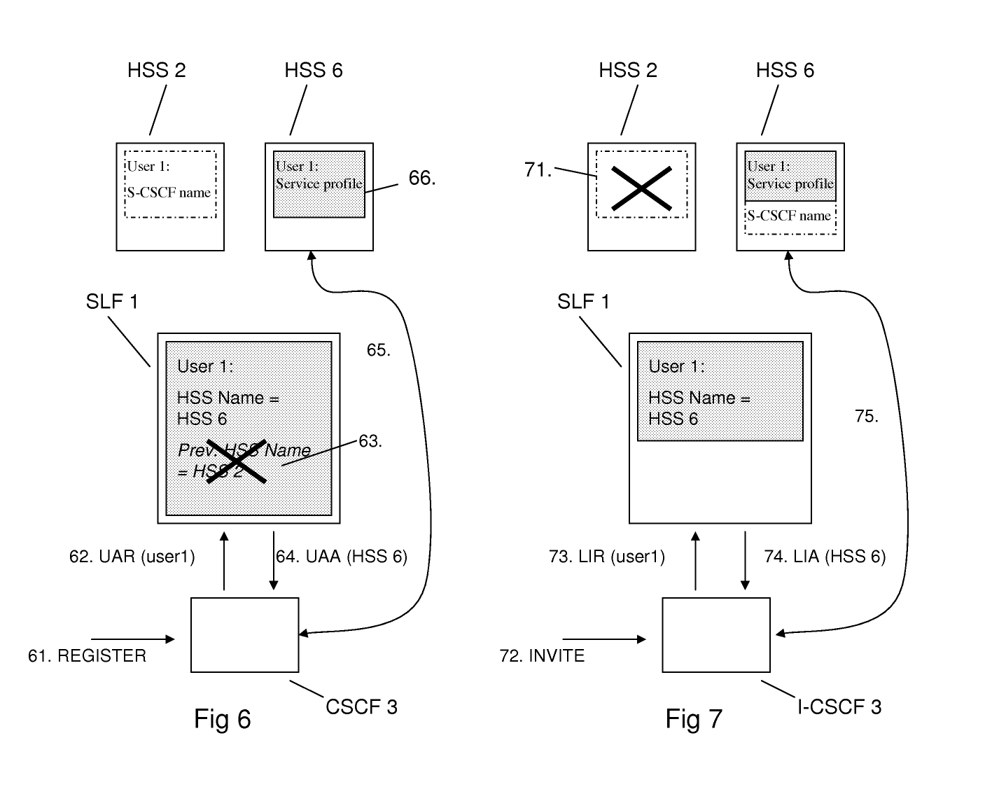

Only when the re-registration takes place, the HSS 6 can become aware of dynamic subscription data of the user1, such as registration status and currently assigned S-CSCF for the user. However, until that time the HSS 6 can be unaware of dynamic subscription information which, however, can be necessary to process terminating calls to the user1. Re-registration will be described in more details with FIG. 6, but before that it is explained in following how the SLF 1 can handle queries 55 relating to terminating requests 54 according to an aspect of the invention.

A received terminating SIP INVITE request 54 can trigger a CSCF 3 to perform an SLF query to find out the name of the HSS which is currently holding subscription data of the called user. The CSCF 3 can transmit a LIR Diameter message 55 to the SLF 1 to request the HSS name. The LIR message 55 can contain an identity of the user, in this example the identity of the user1. The identity of the user can enable the SLF 1 to check the data element 53 of the user1 which can include the name of the HSS currently holding the subscription data of the user1 (HSS 6), as well as, the name of the HSS which was previously holding the subscription data of the user1 (HSS 2). According to an aspect of the invention, the SLF 1 can return the name of the previous HSS 2 of the user1 in a LIA Diameter message 56 if an indication on the previous HSS is still stored in the data element 53 of the user1. Reference number 57 illustrates that the CSCF 3 can continue the session processing with the HSS 2, which can still maintain the dynamic subscription information 52 (S-CSCF name) of the user1. The dynamic subscription information 52 can be needed to successfully complete the session initiation towards the user1.

FIG. 6 shows processing according to an aspect of the invention, when the user1 performs a next (re-)registration after transferring the static subscription data of the user1 from the HSS 2 to the HSS 6. After receiving a SIP REGISTER 61 request associated with the user1, the CSCF 3 can perform an SLF query to find out the name of the HSS which is currently holding subscription data of the user1. The CSCF 3 can transmit a UAR Diameter message 62 to the SLF 1 to request the HSS name. The UAR message 62 can contain an identity of the user, in this example the identity of the user1. The identity of the user can enable the SLF 1 to check the data element 53/63 of the user1 which can include the name of the HSS currently holding the subscription data of the user1 (HSS 6), as well as, the name of the HSS which was previously holding the subscription data of the user1 (HSS 2). According to an aspect of the invention, the SLF 1 can return the name of the current HSS 6 of the user1 in a UAA Diameter message 64. According to an aspect of the invention, the SLF 1 can return the name of the current HSS 6, even if an indication on the previous HSS is still stored in the data element 53 of the user1. According to an aspect of the invention, the SLF 1 can remove the indication on the previous HSS when receiving the UAR message 62 for the user1. The UAR message 62 causing the removal of the indication on the previous HSS 2 can be the first UAR message 62 for the user1 after transferring the subscription data of the user1 from the HSS 2 to the HSS 6. According to an aspect of the invention, the removal can happen before or after or at the same time as transmitting the name of the current HSS 6 in the UAA Diameter message 64. Reference number 65 illustrates that the CSCF 3 can continue the (re-)registration procedure with the HSS 6, which can maintain the (static) subscription information 66 of the user1 needed to complete the (re-) registration procedure. As part of the (re-)registration procedure 65 the HSS 6 can become aware of information which can be considered dynamic, for example, the name of the assigned S-CSCF.

In FIG. 7, after the (re-)registration of FIG. 6 has been completed, a terminating SIP INVITE 72 can be received to initiate a session to the user1. In LIR 73 the CSCF 3 can request a HSS of the user1 (as in LIR 55 of FIG. 5). The SLF 1 can return in LIA 74 the name of the current HSS 6 which can be the only HSS stored for the user 1 in the database of the SLF 1, because the SLF 1 can have removed the indication on the previous HSS during the (re-)registration of FIG. 6 as explained before. Reference number 75 illustrates that the CSCF 3 can continue the session processing with the HSS 6 which can have the necessary subscription information, both static and dynamic, to continue with the terminating session.

Dynamic subscription data 51/71, such as registration status, can be deleted in the previous HSS 2 over time.

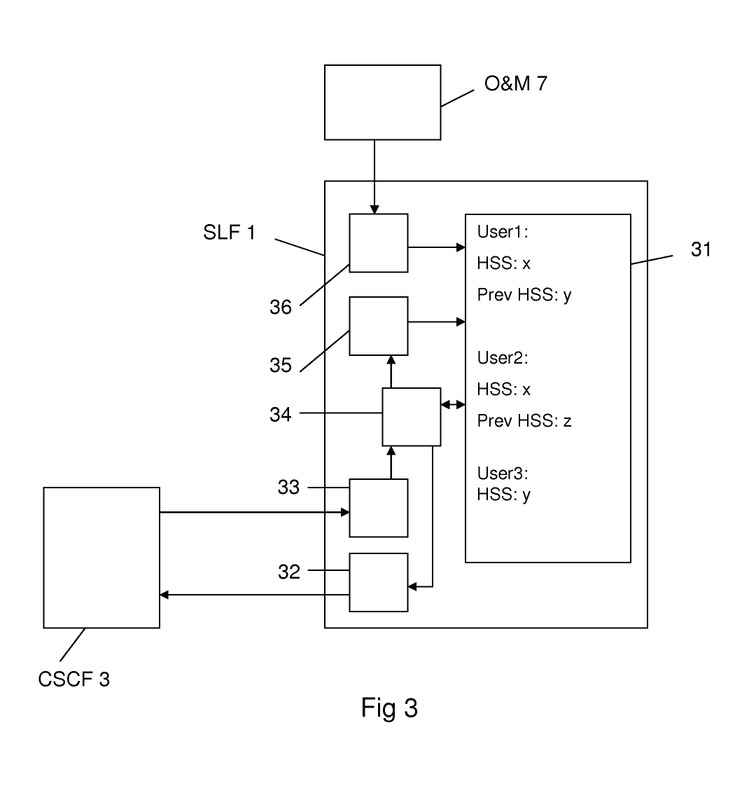

FIG. 3 illustrates an internal structure and functions of an apparatus implementing aspects of the invention. An apparatus 1, which can be an SLF 1, can include a maintaining unit 31 which can contain a user to subscription server mapping for multiple users. For each user one or two entries can be maintained, for example, depending if the configuration of the user in question has recently been changed. If there has been no changes in the subscription server allocation for the user, only the name of currently allocated subscription server can be stored for the user, for example, as shown for user3 in the FIG. 3 which only has parameter “HSS” indicating that HSS (subscription server)=y is currently storing the subscription data of the user3. When the subscription server allocation for a user is changed, also the name of the previously allocated subscription server can be stored for the user, for example, as shown for user1 in the FIG. 3 which has parameter “HSS” indicating that HSS (subscription server)=x is currently storing the subscription data of the user1 and parameter “prey HSS” indicating that HSS (subscription server) =y was previously storing the subscription data of the user1.

An operating unit 36 can be configured to receive configuration information from an operator of the apparatus, such as a telecommunication service provider, for example over O&M interface. The configuration information received by the operating unit 36 can relate to assigning or (re-) allocation of subscription servers to users of the network.

The operating unit 36 can configure information maintained in the maintaining unit 31 accordingly, for example, change the allocated subscription server of a user and/or add a previously allocated subscription server (“prey HSS”) for a user.

A receiving unit 33 can receive queries from other network elements, for example, from a session control entity (CSCF) or an application server (AS). A query can include an identity of a user and can relate to requesting a subscription server for the user. The receiving unit 33 can transmit the query to a processing unit 34 which can be configured to determine to which type of communication event the query relates, for example, if the user is performing a registration action, such as re-registration, or if another user is establishing a terminating communication session to the user. If the query relates to a terminating communication session for the user, the processing unit 34 can be configured to check if a previous subscription server (“prey HSS”) has been stored for the user in the maintaining unit 31. If the previous subscription server is found, the processing unit 34 can be configured to indicate this previous subscription server to a transmitting unit 32 which can transmit the name of the previous subscription server as the allocated subscription server for the user in a response message transmitted to the other network element (CSCF/AS). If no previous subscription server is found for the user, the processing unit 34 can be configured to retrieve from the maintaining unit 31 the currently allocated subscription server (“HSS”) for the user and indicate it to the transmitting unit 32, which in turn can transmit this as the allocated subscription server for the user in a response message transmitted to the other network element (CSCF/AS).

If the query relates to (re-)registration of a user, the processing unit 34 can be configured to contact a removing unit 35 with an indication indicating which user is performing the registration. The removing unit 35 can be configured to remove a possible allocated previous subscription server (“prey HSS”) for the user in the maintaining unit 31, if such exist.

If the query relates to (re-)registration of the user, the processing unit 34 can be configured to retrieve from the maintaining unit 31 the currently allocated subscription server (“HSS”) for the user and indicate it to the transmitting unit 32, which in turn can transmit this as the allocated subscription server for the user in a response message transmitted to the other network element (CSCF/AS).

All units described above in relation to FIG. 3 may be implemented for example using microprocessors, chips and/or other electrical components and/or by software.

The apparatus of FIG. 3 may be physically implemented in a switch, router, server or other hardware platform or electronic equipment which can support data transmission and processing tasks, or can be implemented as a component of other existing device.

For the purpose of the present invention as described herein above, it should be noted that
an access technology via which signaling is transferred to and from a network element or node may be any technology by means of which a node can access an access network (e.g. via a base station or generally an access node). Any present or future technology, such as WLAN (Wireless Local Access Network), WiMAX (Worldwide Interoperability for Microwave Access), BlueTooth, Infrared, and the like may be used; although the above technologies are mostly wireless access technologies, e.g. in different radio spectra, access technology in the sense of the present invention implies also wirebound technologies, e.g. IP based access technologies like cable networks or fixed lines but also circuit switched access technologies; access technologies may be distinguishable in at least two categories or access domains such as packet switched and circuit switched, but the existence of more than two access domains does not impede the invention being applied thereto,
usable access networks may be any device, apparatus, unit or means by which a station, entity or other user equipment may connect to and/or utilize services offered by the access network; such services include, among others, data and/or (audio-) visual communication, data download etc.;
a user equipment may be any device, apparatus, unit or means by which a system user or subscriber may experience services from an access network, such as a mobile phone, personal digital assistant PDA, or computer;
method steps likely to be implemented as software code portions and being run using a processor at a network element or terminal (as examples of devices, apparatuses and/or modules thereof, or as examples of entities including apparatuses and/or modules therefor), are software code independent and can be specified using any known or future developed programming language as long as the functionality defined by the method steps is preserved;
generally, any method step is suitable to be implemented as software or by hardware without changing the idea of the invention in terms of the functionality implemented;
method steps and/or devices, apparatuses, units or means likely to be implemented as hardware components at a terminal or network element, or any module(s) thereof, are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter

Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components; in addition, any method steps and/or devices, units or means likely to be implemented as software components may for example be based on any security architecture capable e.g. of authentication, authorization, keying and/or traffic protection;
devices, apparatuses, units or means can be implemented as individual devices, apparatuses, units or means, but this does not exclude that they are implemented in a distributed fashion throughout the system, as long as the functionality of the device, apparatus, unit or means is preserved,
an apparatus may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device may be regarded as an apparatus or as an assembly of more than one apparatus, whether functionally in cooperation with each other or functionally independently of each other but in a same device housing, for example.

That a subscription server is allocated to a user can mean that the subscription server holds at least some subscription relevant information for or associated with the user. Transferring subscription data of a user from a first subscription server to a second subscription server can mean that the subscription data is provisioned to the second subscription server by maintenance interface of a service provider and removed from the first subscription server.

The invention is not limited to subscription data handling in the IMS network(s), but may also be applied in other type of networks having similar kind of subscription entities and subscription locator entity roles and need to separate handling of more dynamic/temporary type of data from handling of permanent type of user/subscription data, when migrating data between subscription entities. Functions of the subscription locator entity described above may be implemented by code means, as software, and loaded into memory of a computer.

1-24. (canceled)

25. An apparatus, comprising:
means for maintaining information relating to a first subscription server allocated to a user and information relating to a second subscription server previously allocated to the user,
means for indicating a subscription server for the user, wherein the means for indicating is configured to:
indicate the second subscription server as the subscription server for the user, as response to receiving a request associated with a session initiation for the user, and,
indicate the first subscription server as the subscription server for the user, as response to receiving a request associated with registration procedure of the user.

26. An apparatus of claim 25, wherein the means for indicating is configured to indicate the first subscription server instead of the second subscription server as the subscription server for the user as response to receiving a request associated with a session initiation, after receiving a request associated with registration procedure of the user.

27. An apparatus of claim 25, further comprising means for removing the information relating to the second subscription server previously allocated to the user in the maintaining means, as response to receiving a request associated with registration procedure of the user.

28. An apparatus of claim 25, further comprising means for receiving the request associated with the session initiation for the user, wherein the request comprises Location-Info-Request message.

29. An apparatus of claim 25, further comprising means for receiving the request associated with the registration procedure of the user, wherein the request comprises User-Authorization-Request message.

30. An apparatus of claim 25, further comprising means for transmitting the indicated subscription server in a User-Authorization-Answer message or in a Location-Info-Answer message to a call state control function or to an application server.

31. An apparatus of claim 25, further comprising means for changing the information relating to the first subscription server allocated to the user, wherein the means for changing is configured to change the previous information relating to the first subscription server to be the information relating to the second subscription server previously allocated to the user, when changing the information relating to the first subscription server.

32. An apparatus of claim 25, wherein the registration procedure comprises the user refreshing its registration.

33. A method, comprising:
maintaining information relating to a first subscription server allocated to a user and information relating to a second subscription server previously allocated to the user,
indicating a subscription server for the user, wherein the indicating comprises:
indicating the second subscription server as the subscription server for the user, as response to receiving a request associated with a session initiation for the user, and,
indicating the first subscription server as the subscription server for the user, as response to receiving a request associated with registration procedure of the user.

34. A method of claim 33, wherein the indicating comprises indicating the first subscription server instead of the second subscription server as the subscription server for the user as response to receiving a request associated with a session initiation, after receiving a request associated with registration procedure of the user.

35. A method of claim 33, further comprising removing the information relating to the second subscription server previously allocated to the user, as response to receiving a request associated with registration procedure of the user.

36. method of claim 33, further comprising receiving the request associated with the session initiation for the user, wherein the request comprises Location-Info-Request message .

37. A method of claim 33, further comprising receiving the request associated with the registration procedure of the user, wherein the request comprises User-Authorization-Request message.

38. A method of claim 33, further comprising transmitting the indicated subscription server in a User-Authorization-Answer message or in a Location-Info-Answer message to a call state control function or to an application server.

39. A method of claim 33, further comprising changing the information relating to the first subscription server allocated to the user, wherein the changing comprises changing the previous information relating to the first subscription server to be the information relating to the second subscription server previously allocated to the user, when changing the information relating to the first subscription server.

40. A method of claim 33, wherein the information relating to the first subscription server and the information relating to the second subscription server comprises a name or an address of a subscription server.

41. A method, comprising:
transferring subscription data of a user from a first subscription server to a second subscription server,
involving the first subscription server in handling of terminating requests to the user, before the user performs registration procedure, and
involving the second subscription server in handling of terminating requests to the user, after the user has performed the registration procedure.

42. A method of claim 41, wherein the registration procedure comprises the first registration of the user after transferring the subscription data.

43. A method of claim 41, wherein the registration procedure comprises the user refreshing its registration.

44. A method of claim 41, wherein the transferring comprises transferring only part of the subscription data of the user, and wherein the transferred data comprises at least one of a public user identity, a private user identity, a password, filter criteria and a service profile.
